(19) United States
(12) Patent Application Publication
(10) Pub. No.: US 2014/0365139 A1
(43) Pub. Date: Dec. 11, 2014

(54) SYSTEM AND METHOD FOR ASSESSING A CONDITION OF A PATIENT WITH A CHRONIC ILLNESS

(71) Applicant: Temple University, Philadelphia, PA (US)

(72) Inventor: Gerard Joseph Criner, Bryn Mawr, PA (US)

(21) Appl. No.: 14/362,748

(22) PCT Filed: Dec. 4, 2012
(86) PCT No.: PCT/US2012/067775

§ 371 Date: Jun. 4, 2014

Related U.S. Application Data
(60) Provisional application No. 61/566,677, filed on Dec. 4, 2011.

(51) Int. Cl. G06F 19/00

(52) U.S. Cl. CPC G06F 19/3431
USPC 702/19

(57) ABSTRACT

Provided are a method and system for assessing a condition of a patient with a chronic condition. The system includes a storage device that stores a plurality of variables relating to symptoms being experienced by the patient during an exacerbation of the chronic condition. A baseline component establishes a baseline indicative of a normal condition of the patient with the chronic condition while not experiencing an exacerbation. A risk assessment component is operable to compare the condition of the patient as determined based on the variables to the baseline to determine a severity of the exacerbation of the chronic condition relative to the baseline.

### CROSS-REFERENCE TO RELATED APPLICATIONS

This application claims the benefit of U.S. Provisional Application No. 61/566,677, filed Dec. 4, 2011, which is incorporated in its entirety herein by reference.

### BACKGROUND OF THE INVENTION

1. Field of the Invention

The present invention relates in general to management of chronic disease, and in particular, a system and method for determining, using, evaluating, and updating a reference baseline representing a patient's condition.

2. Description of Related Art

In all classes of medical subspecialties, there are chronic illnesses that, by definition, have no “cure” and over time cause gradual or progressive deterioration to a patient's health, wellbeing, and quality of life. In addition to the continuous challenges posed by the underlying chronic disease, patients with chronic illness can occasionally experience acute exacerbations in which their symptoms temporarily worsen. These acute exacerbations can lead to emergency room visits, hospitalization, progression of the underlying disease, and even death. In many cases, acute exacerbations can be prevented (or at least their adverse impact can be diminished) when patients and their healthcare providers receive adequate advance notice regarding any changes to the patient's symptoms. A significant challenge in managing and monitoring changes to a patient's chronic condition—and subsequently identifying impending exacerbations—stems from the absence of a reference that adequately and accurately represents a patient's “normal” health. In other words, because of the effects of chronic illness, patients with chronic conditions are not normally healthy as would be defined in the general population. In addition, the “new normal” or “typical” health profile of each chronic illness patient is highly individualized, due to variations in the presentation of chronic disease as well as various co-morbidities. The absence of a “normal” or “typical” profile for comparison purposes is particularly problematic in the treatment of such patients as clinicians observing a patient's symptoms at a particular point in time have difficulty discerning whether the patient is in fact experiencing (1) a “normal” variation that is typical to the patient, (2) a degradation of that patient's overall chronic condition, or (3) an (impending or occurring) acute exacerbation. As each alternative requires different treatments or interventions, it is imperative that a clinician make an accurate determination in a timely manner.

For one of the most prevalent examples of chronic pulmonary illnesses, chronic obstructive pulmonary disease (“COPD”) exacerbation is the primary cause of hospitalization of patients with COPD. Not only do patients with COPD have a high rate of hospitalization due to COPD, about 1 in 5 patients are readmitted within 30 days of being discharged from the hospital. Exacerbations increase morbidity and mortality, and transiently or permanently worsen quality of life. In addition, exacerbations precipitate a decline in exercise capacity and hasten the progressive loss of lung function. Exacerbations are not only costly to the health of the patient, but also to the hospital causing major loss of revenue due to hospitalizations and emergency room visits that may be avoidable. It is difficult to identify and intervene in the case of impending exacerbations without a reliable baseline comparison.

### BRIEF SUMMARY OF THE INVENTION

Accordingly, there is a need in the art for a method and system that can be utilized by patients with a chronic illness to establish a baseline condition of those patients, and to assess the potential impact of an exacerbation on the patients' health. The method and system can optionally also determine and evaluate the likelihood of an acute exacerbation of a chronic illness.

According to one aspect, the subject application involves a method and system for assessing a patient's respiratory symptoms and objective measurement of airflow and using that to compose an occasionally (e.g., daily) updated integrated index of symptom severity. This integrated index of severity can: (1) serve as an individual patient reference baseline to trigger interventions during periods of worsening symptoms (e.g., assess the severity of an exacerbation based on a deviation from the baseline; (2) be updated and evaluated, after being updated, to assess a patient's burden of disease to determine whether the trajectory of their chronic illness is improving or worsening over time to make more long-term interventions and reduce their risk and symptoms; 3) serve as an educational guide to allow patients to track their own health and learn their symptoms and when different therapies may be indicated to avoid an escalation of their disease and; 4) be compared within individual patients and between patients to determine the patient's condition relevant to themselves and then to the patient's population as a whole. This allows the triaging of care to a group of patients by clinical to be able to more effectively manage a population of COPD patients at daily risk for exacerbations

According to another aspect, the subject application involves a system for assessing a condition of a patient with a chronic condition. The system includes a computer-readable storage device that stores a plurality of variables relating to symptoms being experienced by the patient during an exacerbation of the chronic condition. A baseline component is operable to establish a baseline indicative of a normal condition of the patient with the chronic condition while the patient is not experiencing the exacerbation. A risk assessment component is operable to compare the condition of the patient as determined based on the variables to the baseline to determine a severity of the exacerbation of the chronic condition relative to the baseline.

According to another aspect, the baseline established by the baseline component is indicative of the likelihood that another exacerbation will be experienced by the patient in the future.

According to another aspect, the computer-readable storage device stores at least one rule that generates a response in response to receiving the variables that are indicative of an exacerbation having a severity above a threshold severity.

The above summary presents a simplified summary in order to provide a basic understanding of some aspects of the systems and/or methods discussed herein.

This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an embodiment of a computer system for assessing a condition of a patient with a chronic illness;

FIG. 2 shows an embodiment of a check in interface displayed to a user of a hand-held computer device;

FIG. 3 shows an embodiment of a symptom interface providing a menu of symptom samples selectable by a patient to transmit any symptoms to a server over a communication network;

FIG. 4 shows an embodiment of a summary interface summarizing patient information entered by a patient into a hand-held computer device to be transmitted over a communication network;

FIG. 5 shows an embodiment of a confirmation interface including a Patient Score indicative of a severity of an exacerbation relative to a Baseline specific to the patient;

FIG. 6 shows an embodiment of a history of reports submitted by a patient, where each report includes patient data reflecting symptoms of the patient during an exacerbation of a chronic illness;

FIG. 7 shows an embodiment of a response interface presented to a patient in response to the submission of patient data to a server over a communication network; and

FIG. 8 shows an example of an analysis interface displayed by a clinician terminal, the analysis interface presenting patient information to a clinician in a manner that facilitates comparison of the patient information to historical data, including an Initial Baseline.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

An illustrative embodiment of the present method and system is described herein for determining a reference baseline for use in assessing the condition of patients with a chronic pulmonary illness, specifically chronic obstructive pulmonary disease (“COPD”). It is to be understood, however, that the present method and apparatus are not so limited, and can be utilized to assess the condition of a patient suffering from any chronic illness in an ongoing basis. Once the reference baseline has been established, the reference baseline can be re-assessed after a period time has passed since the reference baseline was initially established to reflect changes in (i.e., update) the “normal” state of the patient's condition as indicated by the reference baseline.

The reference baseline of the individual patient afflicted with COPD can be used in a clinical setting. A patient or clinician can manually enter, or a medical device sensing a quantity or quality of a parameter relating to the patient can transmit values of variables into an algorithm that can be manipulated by a computer processor, which can optionally be remotely located from the patient over a communication network. The computer processor can transmit a set of pre-designated questions to be answered by the patient, and the answers used to input variables to the algorithm for establishing and updating the reference baseline.

An alternate embodiment of the method and system take into consideration differing illness severities, optionally in addition to other illnesses (co-morbidities) that may be inflicting the patient in addition to COPD in establishing the reference baseline. Each patient can input the value of variables (e.g., manually, or through the use of a medical device) to establish a normalized baseline reference point of patient wellness that takes any co-morbidities into account. In particular, a starting point can be established for each individual patient for use in any such system in which the medical status is being monitored, collected and analyzed. This starting point, which can be determined after a predestined period of time, can serve as a reference baseline indicating overall patient status and wellness from the outset of use of the present method and system.

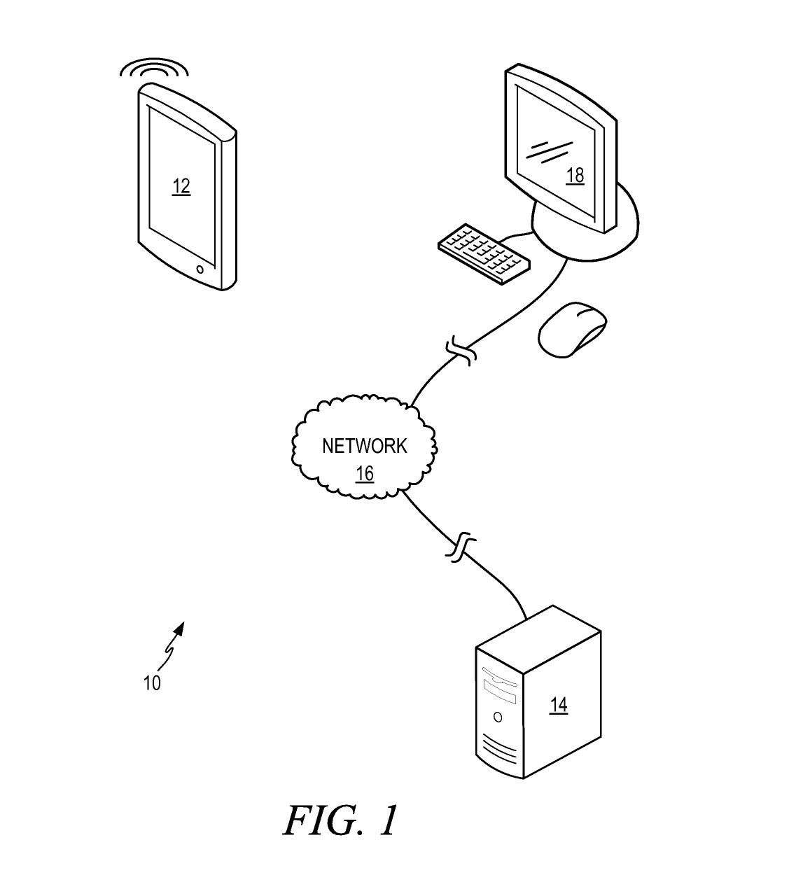

FIG. 1 shows an illustrative embodiment of a computer system 10 that can be utilized to perform the method of assessing the condition of patients with a chronic illness. As shown, the computer system 10 includes a tablet computer 12 operatively connected to communicate with a server 14 over a communication network 16. Although shown and described in the illustrative embodiments as a tablet computer 12, a user computer can be any suitable computing device that can present the user with a form-based interface that can be used to enter responses to questions and other variables to be used in the algorithm such as a desktop computer terminal, laptop or notebook computer terminal, portable handheld device such as a cellular telephone or smartphone, and the like.

The communication network can include components of a local area network (“LAN”), a wide area network (“WAN”) such as the Internet, or a combination thereof. The server 14 is a network-connected terminal with a non-transitory computer-readable memory for storing information input by patients and received over the communication network 16. The server can also optionally be programmed (e.g., with Apache HTTP Server software) to function as a database server, file server, mail server, web server, etc . . . to serve content over the communication network and facilitate the entry of data by users of the tablet computer 12 to establish, update and otherwise interact with the reference baseline as described herein. Computer-executable instructions executed by at least one of the tablet computer 12, server 14 and a clinician terminal 18 described blow can embody a baseline component.

The computer system 10 also includes a clinician terminal 18 that can be used by authorized parties involved in the provision of healthcare to patients to view patient data, or at least a comparison of patient data to the reference baseline. Like the tablet computer 12, the clinician terminal 18 can be operatively connected to communicate with the server 14 over the communication network 16. According to such a network architecture, the tablet computer 12, the clinician computer, or both can be remotely connected to the server 14 over the network 16, instead of being locally and directly connected. Thus, a patient can use the tablet computer 12 at home or other convenient location with Internet access to input the data concerning an exacerbation to seek help in determining whether to seek in-person medical attention during a visit to a healthcare facility such as a hospital.

The computer system 10, or portion thereof, can establish, identify, quantify, measure, compare, and update a baseline signifying a “norm” or “normal” levels that represent an overview, sketch, or representation of a chronic disease patient's condition, including demographics, symptoms, characteristics, and health generally. The “norm” for a patient with a chronic illness can be considered to be the condition of the patient in the absence of an exacerbation, but including symptoms that are expected of a patient with such an illness that cannot be cured. The embodiments used herein to describe the system and method reference a chronic pulmonary illness, specifically COPD as an example, but the chronic illness can be any long-term, and optionally incurable condition.

The tablet computer 12 can be utilized by a patient to enter patient information specific to that patient's COPD condition to establish an Initial Baseline for that patient. The Initial Baseline for a patient is the starting point for reference and later comparison to subsequent evaluations of the patient's COPD condition. The Initial Baseline is determined by obtaining and combining variables that are intrinsically, directly, indirectly, interactively with other variables, or otherwise related to the COPD condition of the patient or the patient's general health. In an illustrative embodiment, the variables used in the determination of the Initial Baseline include a combination of one or more types of variables. Non-limiting examples of such variables include demographic (e.g. gender, age, weight), behavioral (e.g. smoking use, exercise, diet), therapeutic (e.g. medications, oxygen use, therapies), diagnostic (e.g. primary diagnosis, co-morbidities), hospitalizations, medical history, genetics, objective/observed symptoms (e.g. temperature, blood pressure, FEV), and subjective/reported symptoms (e.g. presence of cough, sputum color and quantity). The variables may be located or obtained from a variety of sources, non-limiting examples of which include, physical/paper records, electronic health or medical records, databases, diaries, journals, computers, devices, entries, office visits, telephone calls, emails, texts, smartphone applications, patients, family members, physicians, nurses, healthcare professionals, medical supply companies, or pharmacies. For embodiments that obtain the variable values from electronic sources (e.g., electronic medical records, databases, emails, etc . . . ) the server 14 can be configured to automatically recognize and extract pertinent information based on International Statistical Classification of Diseases and Related Health Problems codes (also referred to as ICD-9 codes). The server 14 or other portion of the computer system 10 can execute computer-executable instructions to perform any of the actions described herein, including the recognition of ICD-9 codes and the extraction of the corresponding data. For embodiments where the variable values are obtained from non-electronic sources, the data can be manually entered into the computer system 10. The system and method require, prompt for, request, obtain, utilize, store, or otherwise identify the date and time that each variable was observed, reported, measured, or otherwise obtained.

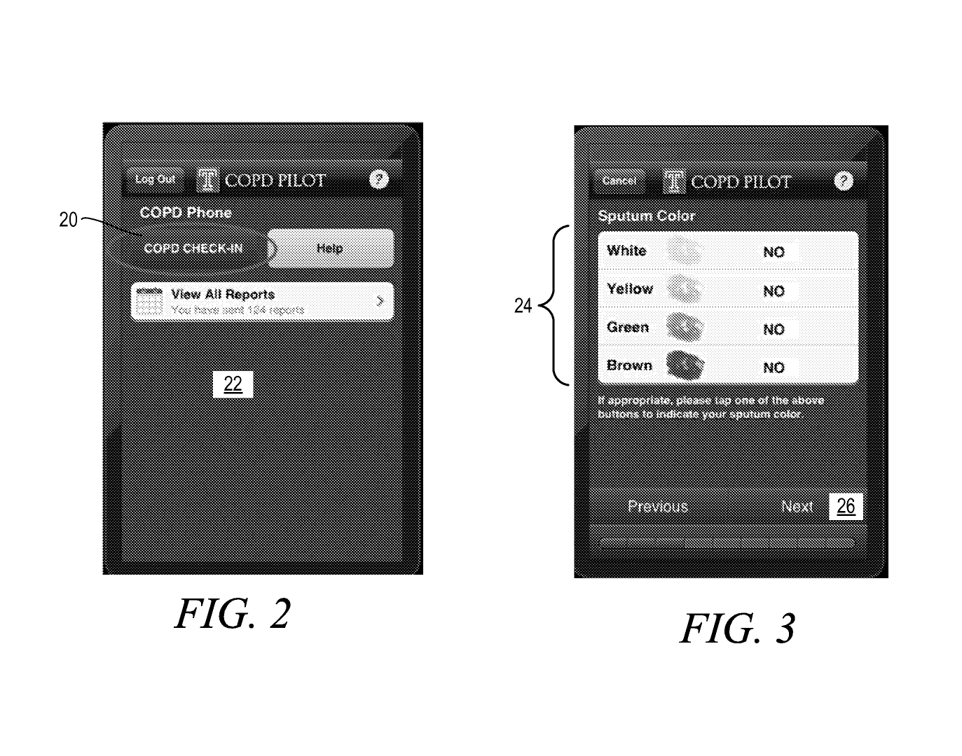

The user interfaces presented by the tablet computer 12 to elicit the patient data from the patient are described with reference to FIGS. 2-. In FIG. 2, the user can select a “check in” option 20 from the check in screen 22 upon experiencing an exacerbation to begin an assessment of the exacerbation and determine whether in-person healthcare is warranted by the exacerbation. Access to the check in option 20 and/or the check in screen 22 can optionally be protected by a password or other security feature to protect any potentially-confidential patient information that may reside on, or otherwise be accessible via the tablet computer 12.

During the check in procedure, the information for determining the Initial Baseline can be input by the user into the interfaces presented by the tablet computer 12. An algorithm can be provided to the tablet computer 12, server 14, clinician terminal 18, or distributed amongst more than one computer, to assign varying degrees of weight or preference to some variables more than others. In a non-limiting example, one or more variables may be combined by way of one or more subcalculations before the final overall calculation is performed. In another non-limiting example, certain components of the calculation may be dependent upon results obtained by one or more subcalculations or one or more variables. The weights assigned to each variable can vary, and be edited by an authorized user. In one non-limiting example, the system and method utilize the most recently obtained data for each variable as identified by any associated date/time stamps in determining the Initial Baseline, updating the value of the Initial Baseline, or obtaining information to compare to the Initial Baseline. In another non-limiting example, the system and method provide an alert if one or more variables or data do not meet a particular recency threshold or criteria (i.e. if the data for one or more variables are considered “out of date” as defined in the system), prompting the user to update their patient data so the Initial Baseline can remain current. In one example, the recency threshold, criteria, or other limit is a variable defined and editable by an end user. The calculation, variables, and other components used to identify the Initial Baseline may be altered, updated, amended, or otherwise edited periodically, manually, or automatically.

An example of the type of patient information collected during a check in procedure can include information concerning sputum coughed up by the patient during an exacerbation. To assist the patient in entering a proper description, the sputum screen in FIG. 3 can present a menu 24 of different colors commonly encountered by patients for comparison purposes. The patient can enter the appropriate selection by touching the display of the tablet computer 12 and selecting a “Next” soft key 26 to proceed to the next question.

Embodiments of the system and method may utilize pre-defined questions to elicit any desired information pertinent to the assessment of an exacerbation from the patient. The questions can seek to elicit information pertaining to at least one of the following conditions: breathlessness (e.g., on a scale from 1 to 10), the excretion of sputum or other substance (e.g., color, consistency, volume or other quantity; expiratory flow (e.g., peak flow measurements), fever, coughing, wheezing, sore throat, nasal congestion. According to other embodiments, the patient information included to be included in the assessment of an exacerbation includes at least one of: COPD classes A,B,C and D based on number of acute exacerbation COPD (“AECOPD”) episodes in the past year, MRC dyspnea class and GOLD stage; severity of AECOPD episodes in past year (e.g., home treated, ER treated, hospitalized, treated in ICU, etc . . . ); use of mechanical ventilation—invasive or noninvasive; use of supplemental oxygen at home, criteria for home oxygen use; receipt of vaccine for flu and/or pneumococcal; evidence of pulmonary hypertension, whether the patient is compliant or noncompliant with meds; whether the patient has been hospitalized or visited an emergency room or other urgent care facility within a predetermined number of days (e.g., within last 30, 60 or 180 days); presence or absence of hypercapnia; whether the patient is a current smoker or has a history of smoking; Medical Research Council (“MRC”) breathlessness scale score; the patient's Forced Expiratory Volume that has been exhaled at the end of the first second of forced expiration (“FEV₁”); whether the patient suffers from obstructive sleep apnea (“OSA”); the patient's obesity; Diabetes Mellitus (“DM”); osteoporosis; whether the patient lives alone; the saturation level of oxygen in the hemoglobin (“SaO₂”); gender; body mass index; Body Mass Index/Obstruction/Dyspnoea/Exercise Capacity (“BODE”) index score; answers to the St. George's Respiratory Questionnaire (“SGRQ”); SF-36; whether the patient suffers from coronary artery disease/congestive heart failure (“CAD/CHF”); chronic bronchitis; percent emphysema (e.g., >35%); whether the patient has an airway wall thickness (“AWT”) greater than a threshold thickness (e.g., AWT>1.75 mm); medications (e.g., tiotropium, inhaled corticosteroid, salmeterol, formoterol, combination of long acting beta agonist and inhaled steroid, statins, chronic azithromycin use, chronic systemic steroid use (daily use >2 weeks), etc . . . ).

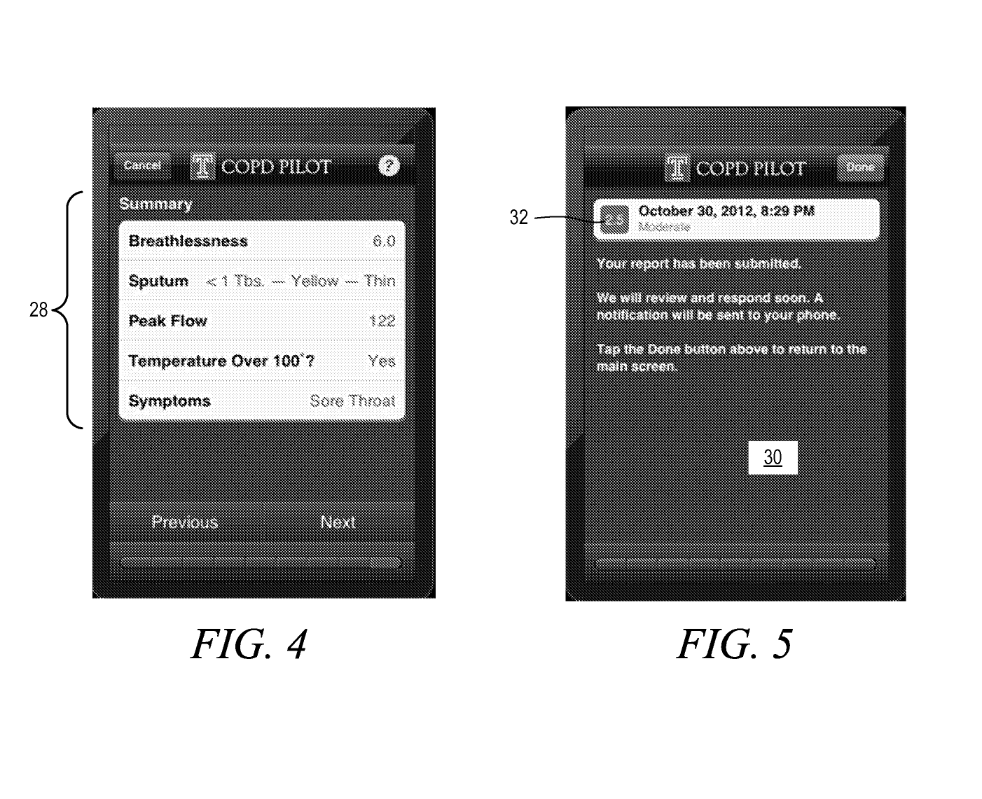

Once the patient data has been entered, the tablet computer 12 can display a summary 28 as shown in FIG. 4 for confirmation purposes. The summary 28 reproduces the information entered by the patient before that information is transmitted over the communication network 16 to be received by the server 14. The collection of such information is collectively referred to herein as a “report”.

After the patient has confirmed the data appearing in the summary and transmitted the data over the communication network 16 to be received by the server 14, a summary confirmation screen 30 such as that shown in FIG. 5 can be displayed by the tablet computer 12. In addition to notifying the patient that the information has been submitted, the summary confirmation screen 30 includes a score 32 (interchangeably referred to herein as a “Patient Score”) assigned to the exacerbation being experienced. The score 32 can be a general, overall indication of the magnitude and/or severity of the exacerbation, and can be an indication of the severity of an exacerbation relative to the Initial Baseline. As shown in FIG. 5, the score 32 has been determined to have a value of “2.5” based on the information entered by the patient, and categorized as “moderate”. The score 32 can optionally be on a scale from 1 to 5 or any other suitable scale, and can be classified as mild, moderate or severe.

Calculation of the score 32 can be performed by an application executed with a computer processor provided to the tablet computer 12, by an application executed with a computer processor provided to the server 14, by an application executed with a computer processor provided to the clinician terminal 18, or distributed amongst a plurality of computer processors provided to the computer system 10. The application executed by the computer processor for determining the score 32 can embody a risk component. For embodiments where such calculations are not performed locally by the tablet computer 12, the calculated score and other such information presented to the patient via the tablet computer 12 is transmitted to the tablet computer 12 over the communication network 16. Each factor can optionally be assigned a value, and the sum of those values calculated to arrive at the score 32, which is indicative of the risk that the patient is experiencing an acute exacerbation. Each factor and its weight can be supported by evidence based data. Some factors such as current smoking increase the risk of an acute exacerbation, while others such as certain medications decrease the risk for an acute exacerbation of COPD. The higher the score 32, the greater the risk of an acute exacerbation.

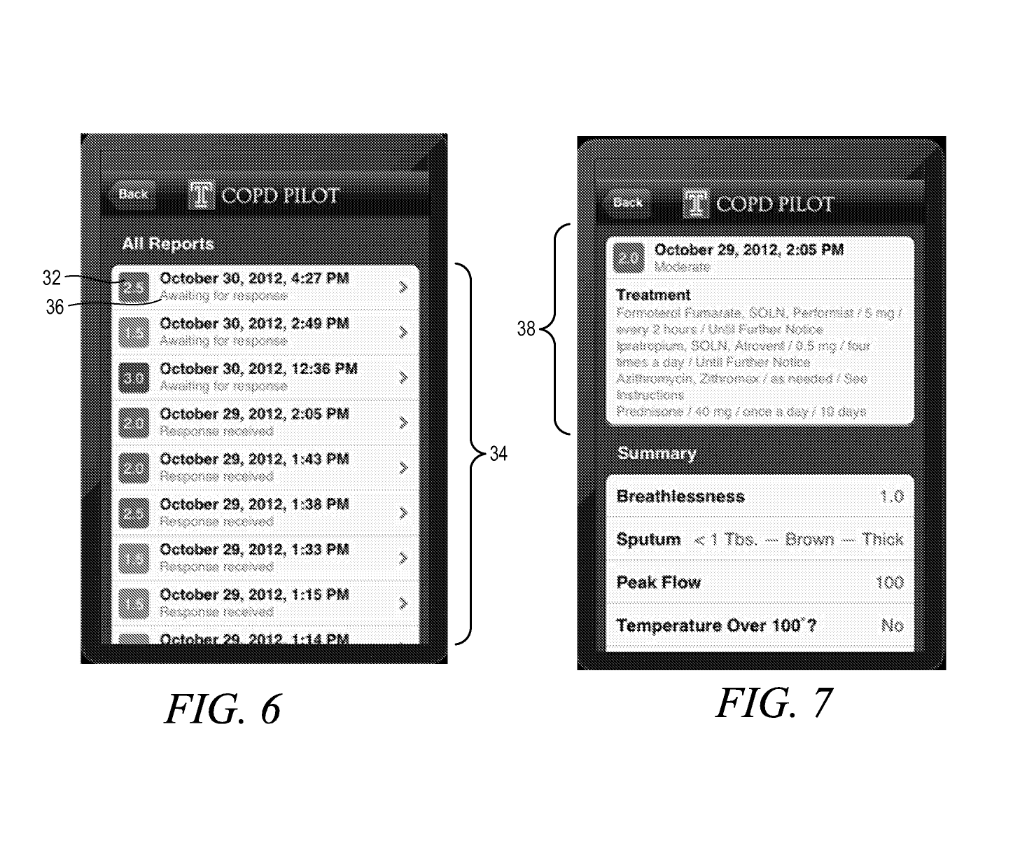

As shown in FIG. 6, a history 34 of previously submitted reports is also made available to be displayed by the tablet computer 12, either from a local computer-readable memory or from a network-accessible computer-readable memory accessible over the communication network 16. Each entry in the history 34 includes its respective score 32 and a status indicator informing the patient whether a response to the report is available. The reports can be opened by the patient to review the information therein, or a recommendation indicating whether an in-person visit to a healthcare facility to receive medical attention is warranted. For example, FIG. 7 shows a report for which a response has been received. The response includes a treatment recommendation 38 that is based on the score 32 for the respective report. Because the exacerbation manifested by the factors submitted for this report is moderate, this particular exacerbation can be treated through medication that may have previously been prescribed to the patient. The treatment recommendation 38 does not specify that personal intervention is necessary, thereby indicating that an in-person visit to an emergency room or other healthcare facility is not necessary for treatment of this exacerbation.

On the receiving end of the reports, the server 14 is configured to extract or otherwise receive the patient information entered by the patient in the appropriate fields displayed by the tablet computer 12. These values are stored by the server 14 in a computer-readable medium such as a hard drive, for example, and used to establish an Initial Baseline value for each of the factors received, along with corresponding time/date stamps that indicate when the Initial Baselines were determined and recorded.

One or more Patient Scores are determined/received by the server 14 in an analogous manner to be subsequently compared to the one or more Initial Baselines, and/or one or more previously-received Patient Scores. Each Patient Score is determined by obtaining the necessary variables and associated data pertaining to a patient's condition as described above and by combining the variables and associated data in accordance with the algorithms/calculations and related parameters as described above. It should be noted that the one or more algorithms/calculations used to obtain one or more Patient Scores may be identical, similar, or altogether different from those used to obtain the one or more Initial Baselines. In one non-limiting example, the system and method involve submitting (e.g., via email, text message or posting) a request (or reminder) for, or otherwise attempt to obtain more recent data for one or more variables related to a patient's condition automatically at periodic intervals once a predetermined amount of time has elapsed (e.g. daily, weekly, monthly, hourly, annually, bi-annually). In another example, procurement of more current data for one or more variables related to a patient's condition is triggered by one or more previously-designated events (e.g. electronic submission or entry by patient, manually by clinical, office visit). According to another embodiment, the system and method obtain or calculate one or more Patient Scores automatically at periodic intervals once a predetermined amount of time has elapsed (e.g. daily, weekly, monthly, hourly, annually, bi-annually). In other examples, calculations of one or more Patient Scores are triggered by one or more previously designated events (e.g. updates to one or more variables, manually by the patient, office visit).

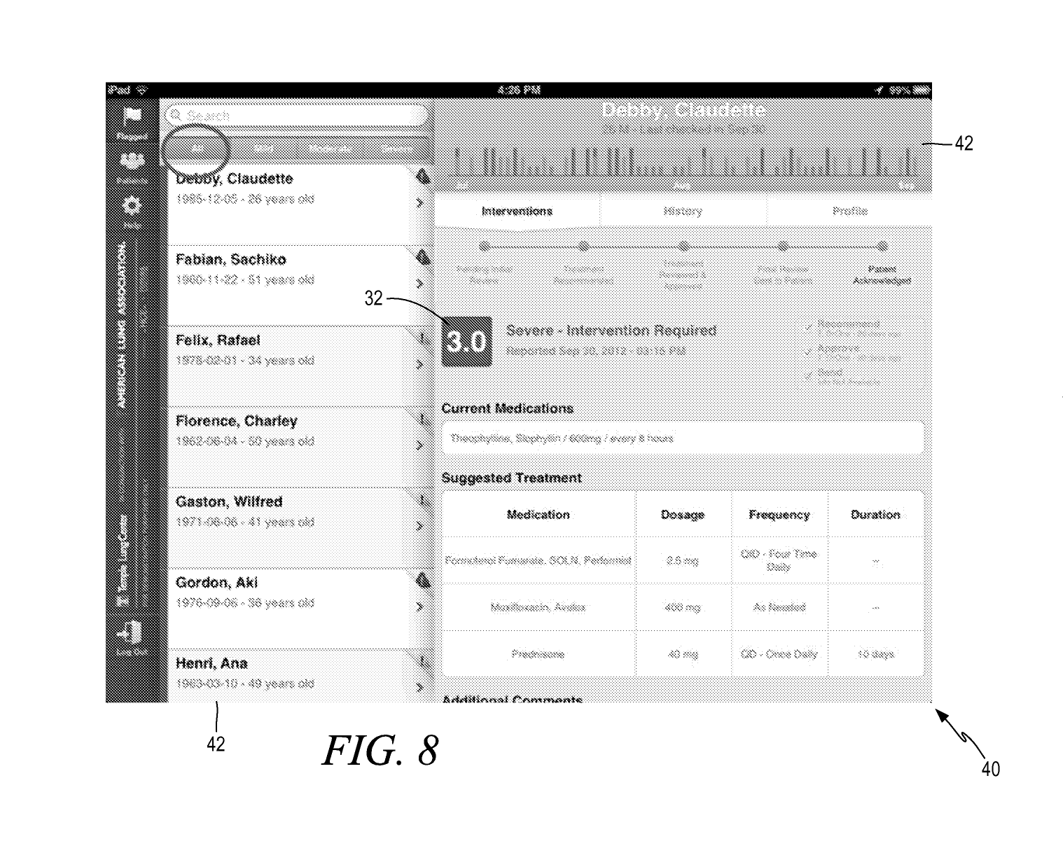

One or more of the Initial Baselines or the Patient Scores, independently or in any combination, may be used in the decision-making process related to one or more patients' care. As shown in FIG. 8, the clinician terminal 18 displays an analysis interface 40 presenting the patient information to a clinician (e.g., physician) in a manner that facilitates comparison of the patient information to historical data, including the Initial Baseline. As shown, the analysis interface 40 includes a patient frame 42 listing the reports from various different patients received over the communication network 16. The reports in the patient frame 42 can be filtered based on the severity of the exacerbation to allow the clinician to first respond to reports with a score 32 indicating a severe, or acute exacerbation that may require the patient visiting a clinician in person for treatment.

Although the clinician can be involved in approving and sending a recommendation to be displayed by the tablet computer 12, rules can be established to automatically respond to a patient. For example, in response to being received by the server 14, reports with a score 32 indicative of a severe exacerbation can trigger an immediate response instructing the patient to seek medical attention. According to alternate embodiments, the computer system 10 can transmit an alert to a patient when a Patient Score in a report submitted by that patient exceeds a predetermined threshold value. Non-limiting examples of such alerts or notification mechanisms include instances which may require at least one of: a change to a patient's medications, treatments, office visits, telephone call or conference with a clinician, or an exacerbation (sudden worsening of symptoms) of a patient's conditions that are predetermined to require intervention or would otherwise result in urgent or emergency care.

In addition to the score 32, the analysis interface 40 includes a graphical depiction of the patient's history 44, showing each report submitted by the patient over an approximately three-month period. Each report included in the history 42 is represented by a bar with a height and color indicative of the severity of the report relative to the Initial Baseline. With the historical data presented in such a manner, the clinician can readily observe trends in the frequency and/or severity of exacerbations and customize any recommendation to address such trends.

The system described above obtains one or more Patient Scores and compares such Patient Scores to the Initial Baseline scores. Although variations of the algorithms and calculations used to achieve Baseline and Patient Scores are within the scope of this disclosure, the present system and method can use a common algorithm and/or variables to conduct the comparison of the Initial Baseline and Patient scores so valid (e.g., apples-to-apples) comparisons can be achieved. The system provides for an assortment of risk stratification, decision criteria, alert thresholds, or other mechanisms for highlighting instances where one or more Patient Scores require the attention, action, acknowledgement, or other reaction by an end user. In one embodiment, the system alerts one or more end users when a Patient Score exceeds a predetermined threshold. Regardless of the algorithms used, comparisons of one or more Patient Scores to a Baseline can be initiated through a time-event combination (e.g. 30 days after a hospital discharge). The system and method described herein may compare the one or more Patient Score to one or more Baselines automatically or manually. The basis for the one or more comparisons to be altered, amended, edited, or updated by the end user.

Due to the nature of chronic conditions in which patients' overall health, symptoms, and general condition worsen or degrade over time, the Initial Baseline can optionally evolve or change or need to be examined, evaluated, or even updated if or when they are no longer an accurate representation of a patient's “norm.” To evaluate one or more Baselines for accuracy as being representative or providing a “norm” reflecting a patient's current chronic condition (i.e., the new norm, and not an acute, short-term, temporary change), the system can detect a change in the pattern of symptoms, severity, recommendations, etc . . . based on reports received from the patient over time. For example, the system can automatically (i.e., without clinician intervention) detect when a certain number of personal interventions (requiring the patient to visit an emergency room or health care provider) are required within a particular period. According to alternate embodiments, the Baseline can be deemed to need an update in response to receiving a plurality of Patient Scores that differ from the then-current Baseline by a predetermined threshold, or that persist for longer than a predetermined duration.

According to alternate embodiments, the system can automatically update the then-current Baseline in response to receiving a manually-entered instruction to do so. Yet other embodiments can schedule an update to the then-current Baseline in response to a visit by the patient to a healthcare facility, after a predetermined period of time following such a visit, or in response to a frequency of such visits. Regardless of the triggering event, the then-current Baseline can be updated based on historical data associated with the patient, such as the data graphically represented in the patient's history 42.

According to other embodiments, when a Baseline is evaluated, the variables, data, time stamps, and Patient Scores are used, in addition to s algorithms, calculations, and various data analyses that measure, evaluate, assess, and then report whether more recent Patient Scores regress to the mean representing the Baseline or whether the more recent Patient Scores represent a long-term shift or deviation from the Baseline that is observable, predictable, or quantifiable as a New Baseline. As a non- limiting example, the present system sifts the “noise” or variability characteristic of normal variances or attributable to acute exacerbations that are insignificant (in the case of normal variance—i.e., beyond a predetermined standard deviation) or temporary (in the case of acute exacerbations) from statistically or otherwise significant more long-term changes in one or more underlying chronic conditions. In cases where the system and method indicate that the one or more Initial (or other then-current) Baselines are no longer accurate, the system may either automatically, or at the manual discretion of the end use, update, edit, modify, or replace the one or more Initial Baseline with one or more New Baselines, optionally include one or more date/time stamps. It should be noted that while chronic conditions are more often the result of long-term worsening of conditions, it is not impossible for a New Baseline to represent improved conditions from an Initial (or other) Baseline. It is within the scope of the present disclosure for the system and method to perform more than one evaluation of each Baseline (Initial or otherwise) over time, and from time to time. It is also within the scope of the present disclosure to use the data associated with changes in any Baseline to further refine the algorithms, calculations, decision-criteria, risk stratification, therapies, treatment standards, or any or all other information or components used in the care of patients with chronic conditions. Once a New Baseline is established, the system and method compares subsequent Patient Scores to the New Baseline for the purposes described above associated with decision-making, threshold criteria, risk stratification, or other alert mechanisms.

The description above focuses on determining a severity of an active exacerbation reflecting the risk posed by the exacerbation to the health of the patient based on a deviation from the then-current Baseline, and responding with a recommended course of treatment based on that deviation. The recommended course of treatment can optionally include a personal visit to a healthcare facility to receive medical attention, taking a prescribed medication, or a combination thereof. Instead of, or in addition to assessing the severity of an active exacerbation being experienced by the patient, alternate embodiments of the method and system can utilize the then-current Baseline determined from the patient information input by the patient via the tablet computer 12 to predict the likelihood of a future acute exacerbation of a chronic illness. In other words, the Baseline is indicative of the likelihood of a future exacerbation occurring for a patient not currently experiencing an exacerbation, and a deviation of a Patient Score from the Baseline is indicative of the severity of an active exacerbation currently being experienced by the patient.

The computer system 10 can produce an Acute Exacerbation COPD Risk Score (“AECOPD Risk Score”) that is indicative of a chronic disease patient's current condition, including demographics, symptoms, characteristics and health generally, considered risk factors for initiating future acute exacerbations. Illustrative examples of the variables that can be used to calculate the Acute Exacerbation COPD Risk Score include at least one of demographic (e.g. gender, age, weight), behavioral (e.g. smoking use, exercise, diet), therapeutic (e.g. medications, oxygen use, therapies), diagnostic (e.g. primary diagnosis, co-morbidities), hospitalizations, medical history, genetics, objective/observed symptoms (e.g. temperature, blood pressure, FEV), and subjective/reported symptoms (e.g. presence of cough, sputum color and quantity). According to one embodiment the variables may be obtained from a variety of sources and input to the computer system 10. For instance, the variables can include data from at least one of physical/paper records, electronic health or medical records, databases, diaries, journals, computers, devices, entries, office visits, telephone calls, emails, texts, smartphone applications, patients, family members, physicians, nurses, healthcare professionals, medical supply companies, or pharmacies. In another embodiment, the system and method described herein requires, prompts for, requests, obtains, utilizes, stores, or otherwise identifies the date and time that each variable was observed, reported, measured, or otherwise obtained.

The algorithm for determining AECOPD Risk Score is calculated by quantifying the variables and combining them using an algorithm or calculation that may provide varying degrees of weight or preference to some variables more than others. In a non-limiting example, one or more variables may be combined by way of one or more subcalculations before the final overall calculation is performed. In another non-limiting example, certain components of the calculation may be dependent upon results obtained by one or more subcalculations or one or more variables. As another non-limiting example, none, one, or more of the weights given to each variable may be the same.

The algorithm and variables for determining the AECOPD risk score may be altered, updated, amended, or otherwise edited periodically, manually, or automatically. Additionally, the algorithm may be related to one or more primary diagnoses, chronic conditions, co-morbidities, or patients.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for assessing a condition of a patient with a chronic condition, the system comprising:
a computer-readable storage device that stores a plurality of variables relating to symptoms being experienced by the patient during an exacerbation of the chronic condition;
a baseline component that is operable to establish a baseline indicative of a normal condition of the patient with the chronic condition; and
a risk assessment component that is operable to compare the condition of the patient as determined based on the variables to the baseline to determine a severity of the exacerbation of the chronic condition relative to the baseline.

2. The system of claim 1, wherein the baseline established by the baseline component is indicative of a likelihood that another exacerbation will be experienced by the patient in the future.

3. The system of claim 1, wherein the computer-readable storage device stores a rule that generates a response in response to receiving the variables that are indicative of an exacerbation having a severity above a threshold severity.
